(19) United States
(12) Patent Application Publication
(10) Pub. No.: US 2004/0093368 A1
(43) Pub. Date: May 13, 2004

(54) Method and apparatus for fixed codebook search with low complexity

(76) Inventors: Eung Don Lee, Daejeon-city (KR); Do Young Kim, Daejeon-city (KR); Tae Bong Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/671,649

(22) Filed: Sep. 26, 2003

(30) Foreign Application Priority Data
Nov. 11, 2002 (KR) 2002-69600

(51) Int. Cl. G06F 7/32

(52) U.S. Cl. 708/520

(57) ABSTRACT

There are provided a method and apparatus for fixed codebook search with low complexity used in a sound codec according to the Code Excited Linear Prediction (CELP) coding algorithm. The method includes: calculating absolute values of pulse position likelihood estimation vectors for respective pulse positions for each track in a plurality of tracks; selecting a predetermined number of the pulse position for each track in a descending order of the absolute values of the pulse position likelihood estimation vectors; selecting one pulse position among the selected pulse positions for each track, per each track, creating all possible pulse position combinations consisting of the selected pulse positions, and conducting complete search for the all possible pulse position combinations; and selecting one pulse position combination among the all possible pulse position combinations subjected to the complete search. Therefore, it is possible to significantly reduce the calculation amount required for fixed codebook search of a sound codec.

### BACKGROUND OF THE INVENTION

This application claims the priority of Korean Patent Application No. 2002-69600, filed on Nov. 11, 2002, in the Korean Intellectual Property Office, the disclosure of which is incorporated herein in its entirety by reference.

1. Field of the Invention

The present invention relates to a method and apparatus for fixed codebook search with low complexity, and more particularly, to a method and apparatus for fixed codebook search used in a sound codec according to the Code Excited Linear Prediction (CELP) coding algorithm.

2. Description of the Related Art

Various methods have been used for converting sound into digital signals suitable to be transmitted to a user. Particularly, in a mobile communication environment, it is desired to transfer more user's sounds on a limited channel and transmit high-quality sounds at a lower transmission bit-rate. Such a function that converts sounds into digital signals and compresses the digital signals is performed by a vocoder. The vocoder, as a device for sound coding, may be a waveform codec, a source codec, a hybrid codec, and the like. The Code Excited Linear Prediction (CELP) codec is a type of a hybrid codec utilizing a compression algorithm used for encoding sound at a lower transmission bit-rate. The CELP codec can create high-quality sound signals at a transmission bit-rate lower than 16 kbps.

The CELP codec constitutes a codebook using different white gaussian noises. The CELP codec transmits, instead of a sound signal, an index corresponding to optimal white gaussian noise in which an error between an input sound signal and synthesized sound is minimized, thereby obtaining a compression effect. Also, the channel capacity of a gateway according to the Voice over Internet Protocol (VoIP) is greatly dependent on the complexity of the sound codec. The complexity of a sound codec using the CELP coding algorithm is decided according to methods for fixed codebook search.

Table 1 shows a fixed codebook structure of a G.729 sound codec.

TABLE 1

| Track | Pulse | Code | Pulse position |
|---|---|---|---|
| 0 | i₀ | S₀: ±1 | m₀: 0 5 10 15 20 25 30 35 |
| 1 | i₁ | S₁: ±1 | m₁: 1 6 11 16 21 26 31 36 |
| 2 | i₂ | S₂: ±1 | m₂: 2 7 12 17 22 27 32 37 |
| 3 | i₃ | S₃: ±1 | m₃: 3 8 13 18 23 28 33 38 |
| | | | 4 9 14 19 24 29 34 39 |

As shown in Table 1, pulses i₀, i₁, i₂, and i₃ are located in tracks 0, 1, 2, and 3, respectively. Each pulse has a value of +1 or −1. Also, pulse position indexes 0, 5, 10, . . . , 35 are in track 0, pulse position indexes 1, 6, 11, . . . , 36 are in track 1, pulse position indexes 2, 7, 12, . . . , 37 are in track 2, and pulse position indexes 3, 8, 13, . . . , 39 are in track 3. In this case, searching for a fixed codebook refers to searching for an optimal pulse position for each track of the tracks 0, 1, 2, and 3.

A fixed codebook vector of the G.729 standards has only 4 pulse positions among 40 pulse positions (equal to the sample number of subframes), where each value of the pulses is limited into −1 or +1. Each of the four pulse positions can be selected from each track of the four tracks shown in Table 1. The track 3 has 16 pulse positions, differently from other tracks. This is an inherent characteristic of the G.729 standards. In this case, searching for the fixed codebook refers to searching for four most optimal pulse positions and codes among the 40 pulse positions.

Among methods for fixed codebook search, a complete search method used in a 6.3kbps sound codec according to the G.723.1 standards is a method that searches all possible pulse positions. Therefore, a high-quality sound can be obtained using this method. However, such a complete search method requires a large calculation amount, and accordingly, is time consuming.

To solve this problem, a focused search method is used in a 5.3 kbps sound codec according to the G.729 or the G.723.1 standards. The focused search method predetermines a threshold value in consideration of respective pulse positions of tracks 0, 1, and 2, creates pulse position combinations by selecting one pulse position for each track, compares the threshold value with a summed value of the absolute values of correlation vectors for each pulse position combination, adds the pulse positions of the track 3 to the pulse positions combinations above the threshold value to creates new pulse position combinations, and searches for the new pulse position combinations. However, such a focused search method has a problem in that a large calculation amount is required and calculation complexity is not uniform since all combinations for the respective pulse positions of the tracks 0, 1, and 2 are compared to the threshold value.

To solve the above problem, a sound codec according to the G.729A standards, the Adaptive Multi Rate-Narrow Band (AMR-NB) standards, or the Adaptive Multi Rate-Wide Band (AMR-WB) standards utilizes a depth first tree search method. According to the depth first tree search method, several candidate pulse positions in one of two tracks are first selected according to their correlation values, pulse positions of the other track are added respectively to the candidate pulse positions to create pulse position combinations, and then search is conducted for the pulse position combinations. Therefore, a calculation amount can be greatly reduced and the complexity calculation is uniform. Nevertheless, this depth first tree search method also has a problem in that the calculation amount is still great for obtaining a good output tone quality.

### SUMMARY OF THE INVENTION

The present invention provides a method for fixed codebook search, capable of greatly reducing a complexity calculation for obtaining a good output tone quality by significantly reducing the time required for fixed codebook search in a sound codec.

According to an aspect of the present invention, there is provided a method for fixed codebook search comprising: calculating absolute values of pulse position likelihood estimation vectors of pulse positions for each track in a plurality of tracks; selecting a predetermined number of pulse positions for each track in a descending order of the absolute values of the pulse position likelihood estimation vectors; selecting one pulse position among the selected pulse positions for each track, per each track, creating all possible pulse position combinations consisting of the selected pulse positions, and conducting a complete search for the all possible pulse position combinations; and selecting one pulse position combination among the all possible pulse position combinations subjected to the complete search.

According to another aspect of the present invention, there is provided an apparatus for fixed codebook search comprising: a unit for calculating an absolute value of a pulse position likelihood estimation vector, which calculates absolute values of pulse position likelihood estimation vectors for respective pulse positions for each track; a pulse position selector which selects a predetermined number of pulse positions for each track in a descending order of the absolute values of the pulse position likelihood estimation vectors, using the absolute value information of the pulse position likelihood estimation vectors; a unit for conducting a complete search, which selects one pulse position among the selected pulse positions for each track, per each track, creating all possible pulse position combinations consisting of the selected pulse positions, and conducts complete search for the all possible pulse position combinations; and an optimal pulse position selector which selects one pulse position combination among the all possible pulse position combinations subjected to the complete search.

According to still another aspect of the present invention, there is provided a computer readable medium having embodied thereon a computer program for the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a flow chart illustrating a method for fixed codebook search, according to an embodiment of the present invention; and

FIG. 2 is a block diagram of an apparatus for fixed codebook search, according to an embodiment of the present invention.

### DETAILED DESCRIPTION OF THE INVENTION

Hereinafter, embodiments of the present invention will be described in detail with reference to the appended drawings.

In searching for a fixed codebook, a codebook vector is selected using Equation 1.

$$Max \frac{{C}_{k}^{2}}{{E}_{k}} = Max \frac{{( {d}^{t} {c}_{k} )}^{2}}{{c}_{k}^{t} Φ {c}_{k}} , \qquad ( 1 )$$

wherein cₖ is a k-th fixed codebook vector, superscript t indicates a transpose of a matrix or a vector, d is a correlation vector, and Φ is a correlation between the correlation vector d and an impulse response of a linear estimation synthesis filter.

The correlation Φ is calculated by Equations 2 and 3, as follows.

$$\begin{matrix}d ( n ) = {\sum }_{i = n}^{39} {x}_{2} ( i ) ( i - n ) , i = 0 , … , 39 & ( 2 ) \\ Φ ( i , j ) = {\sum }_{n = j}^{39} h ( n - i ) h ( n - j ) , i = 0 , … , 39 , j = i , … , 39 & ( 3 )\end{matrix}$$

In Equation 2, x₂(n) is a target signal to be subjected to fixed codebook search, and h(n) is an impulse response of a low-pass (LP) synthesis filter. Also, C and E values in above Equation 1 are calculated by Equations 4 and 5, as follows.

$$\begin{matrix}C = {\sum }_{i = 0}^{3} sign \{ b ( i ) \} d ( {m}_{i} ) & ( 4 ) \\ E = {\sum }_{i = 0}^{3} Φ ( {m}_{i} , {m}_{i} ) + 2 {\sum }_{i = 0}^{2} {\sum }_{j = i + 1}^{3} sign \{ b ( i ) \} sign \{ b ( j ) \} Φ ( {m}_{i} , {m}_{j} ) , & ( 5 )\end{matrix}$$

wherein mᵢ is an i-th pulse position, and b(n) is a pulse position likelihood estimation vector and calculated by Equation 6.

$$b ( n ) = \frac{{r}_{LTP} ( n )}{\sqrt{{\sum }_{i = 0}^{39} {r}_{LTP} ( i ) {r}_{LTP} ( i )}} + \frac{d ( n )}{\sqrt{{\sum }_{i = 0}^{39} d ( i ) d ( i )}} , \qquad ( 6 )$$

wherein, r_{LTP}(n) is a pitch residue signal.

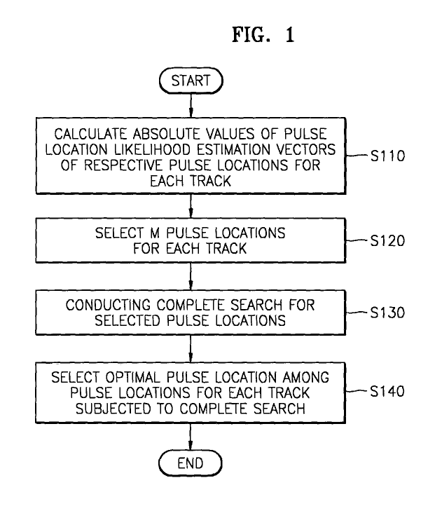

FIG. 1 is a flow chart illustrating a method for fixed codebook search, according to an embodiment of the present invention.

Referring to FIG. 1, first, a pulse position likelihood estimation vector value of each pulse position for each track in a plurality of tracks is calculated (step S110). More specifically, an absolute value |b(n)| of the pulse position likelihood estimation vector of each pulse position for each track is calculated. The pulse position likelihood estimation vector is a vector including probability information regarding an optimal pulse position.

Table 2 lists the absolute values of pulse position likelihood estimation vectors of respective pulse positions for tracks 0,1, 2, and 3 in a specific subframe of the G.729 standards.

Generally, in a sound codec according to the Code Excited Linear Prediction (CELP) protocol, a sound sample is first divided into frames and the frame is divided into several subframes. These divisions are needed because there are cases where each frame is processed or each subframe is processed in sound coding and decoding.

For example, if a frame length of the G.723.1 standards is 30msec (240 samples when sampled at 8 kHz) and a subframe length of the G.723.1 standards is 7.5msec (60 samples when being sampled at 8 kHz), one frame consists of four subframes. Also, if the frame length of the G.729 standards is 10 msec (80 samples when sampled at 8 kHz) and the subframe length of the G.729 standards is 5 msec (40 samples when sampled at 8 kHz, as 40 pulse positions shown in the fixed codebook structure of the G.729 standards of Table 1), one frame consists of two subframes. As such, the fixed codebook search is to search for these subframes.

TABLE 2

| Track | Absolute value of pulse position likelihood estimation vector | | | | | | | |
|---|---|---|---|---|---|---|---|---|
| 0 | 0.10 | 0.31 | 0.15 | 0.02 | 0.10 | 0.17 | 0.67 | 0.35 |
| 1 | 0.29 | 0.07 | 0.06 | 0.21 | 0.00 | 0.04 | 0.32 | 0.00 |
| 2 | 0.36 | 0.17 | 0.06 | 0.04 | 0.34 | 0.29 | 0.66 | 0.05 |
| 3 | 0.18 | 0.08 | 0.43 | 0.06 | 0.10 | 0.48 | 0.16 | 0.12 |
| | 0.33 | 0.05 | 0.13 | 0.26 | 0.11 | 0.11 | 0.11 | 0.05 |

Then, M pulse positions for the respective tracks are respectively selected (step S120). Using the absolute values of the pulse position likelihood estimation vectors obtained in the previous step S110, there are selected only M pulse positions in a descending order of absolute values of the pulse position likelihood estimation vectors for each track. Referring to Tables 1 and 2, for example, in the case where M=3, pulse positions 30, 35, and 5 having values 0.67, 0.35, and 0.31 respectively are selected in track 0, pulse positions 31, 1, and 16 having values 0.32, 0.29, and 0.21 respectively are selected in track 1, pulse positions 32, 2, and 22 having values 0.66, 0.36, and 0.34 respectively are selected in track 2, and pulse positions 28, 13, and 3 having values 0.48, 0.43, and 0.18 respectively and pulse positions 4, 19, and 14 having values 0.33, 0.26, and 0.13 respectively are selected in track 3. These selected results are listed in Table 3.

In the case where M=2, since only two pulse positions for each track should be selected in a descending order from the greatest absolute value of the pulse position likelihood vectors, pulse positions 30 and 35 are selected in track 0, pulse positions 31 and 1 are selected in track 1, pulse positions 32 and 2 are selected in track 2, and pulse positions 28, 13 and 4, 19 are selected in track 3.

Table 3 shows selected pulse positions in the case where the number (M) of pulse positions for each track selected as candidates of an optimal pulse position is set to three and in the case where the number (M) of the pulse positions for each track is set to two, in a specific frame of the G.729 standards. The upper side of Table 3 is the case of M=3 and the lower side is the case of M=2.

TABLE 3

| Track | Selected pulse position | | |
|---|---|---|---|
| 0 | 5 | 30 | 35 |
| 1 | 1 | 16 | 31 |
| 2 | 2 | 22 | 32 |
| 3 | 3 | 13 | 28 |
| | 4 | 14 | 19 |

| | |
|---|---|
| Track | Selected pulse position |

| | | |
|---|---|---|
| 0 | 30 | 35 |
| 1 | 1 | 31 |
| 2 | 2 | 32 |
| 3 | 13 | 28 |
| | 4 | 19 |

Next, a complete search is conducted for the pulse positions selected as in Table 3 (step S130). First, one pulse position for each track is selected, respectively. Thus, all possible combinations consisting of the respective pulse positions for the respective tracks are created and complete search is conducted for the all possible combinations. For example, in the case of M=3, the complete search process is described as follows. Equation 1 is calculated for all combinations (5,1,2,3), (5,1,2,4), (5,1,2,13), . . . , (5,1,2,28), (5,1,2,19), (5,1,22,3), (5,1,22,4), . . . , (5,1,22,28), (5,1,22,19), . . . , (35,31,32,28), (35,31,32,19) created by selecting one pulse position from each of the four tracks, respectively.

If the number of the pulse positions selected for each track of the G.729 sound codec is three, searches of 3×3×3×(3+3)=162 counts are conducted. If the number of the pulse positions selected for each track is two, searches of 2×2×2×(2+2)=32 counts are conducted.

Next, an optimal pulse position is selected among the selected pulse positions for each track subjected to complete search (step S140). That is, the complete searches for the selected pulse positions are first conducted and then an optimal pulse position satisfying above Equation 1 is selected. Thus, a fixed codebook search for subframes is terminated. As a result, an optimal pulse position combination is output.

Therefore, It is possible to significantly reduce the calculation amount required for the fixed codebook search of the sound codec, by applying the complete search method for only several pulse positions having greater probability to be an optimal pulse position in each track.

Also, the fixed codebook search method of the sound codec, according to the present invention, can be utilized for various types of fixed codebook searches having an algebraic codebook structure.

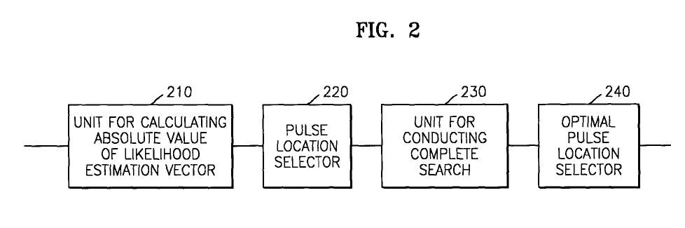

FIG. 2 is a block diagram of a fixed codebook search apparatus, according to the present invention.

Referring to FIG. 2, a unit 210 for calculating an absolute value of a pulse position likelihood estimation vector calculates the absolute values of the pulse position likelihood estimation vectors for the respective pulse positions for each track. That is, the absolute values of the pulse position likelihood vectors are calculated for each track using Equation 6.

A pulse position selector 220 selects M pulse positions in a descending order of the absolute values of the pulse position likelihood estimation vectors per a track using the absolute value information of the likelihood estimation vectors.

A complete search unit 230 performs a complete search for the pulse positions selected from the pulse position selector 220.

An optimal pulse position selector 240 selects an optimal pulse position among the pulse positions for each track subjected to the complete search. That is, the optimal pulse position selector 240 selects an optimal pulse position satisfying Equation 1.

As described above, according to the present invention, it is possible to significantly reduce the calculation amount required for fixed codebook search of a sound codec.

According to a test result, in the case of selecting two pulse positions per a track by applying the present invention to a G.729A sound codec, a Perceptual Evaluation of Speech Quality (PESQ) Mean Opinion Score (MOS) value of 0.15 is obtained, lower than a conventional technique in view of tone quality, and a search count of 32 is achieved, compared to the search count of 192 of the conventional technique, which proves a significant reduction of the calculation amount.

The present invention may be embodied as a program on a computer readable medium including, but not limited to storage media, such as magnetic storage media (e.g., ROM's, floppy disks, hard disks, etc.), optically readable media (e.g., CD-ROMs, DVDs, etc.) and carrier waves (e.g., transmissions over the Internet). To be executed in an independent or present invention may be embodied as a distributed manner.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for fixed codebook search comprising:
calculating absolute values of pulse position likelihood estimation vectors of pulse positions for each track in a plurality of tracks;
selecting a predetermined number of pulse positions for each track in a descending order of the absolute values of the pulse position likelihood estimation vectors;
selecting one pulse position among the selected pulse positions for each track, per each track, creating all possible pulse position combinations consisting of the selected pulse positions, and conducting a complete search for the all possible pulse position combinations; and
selecting one pulse position combination among the all possible pulse position combinations subjected to the complete search.

2. The method of claim 1, wherein in selecting one pulse position combination among the all possible pulse position combinations subjected to the complete search, a pulse position combination satisfying the following equation is selected:
$$Max \frac{{C}_{k}^{2}}{{E}_{k}} = Max \frac{{( {d}^{t} {c}_{k} )}^{2}}{{c}_{k}^{t} Φ {c}_{k}} ,$$
wherein cₖ is a k-th fixed codebook vector, superscript t indicates a transpose of a matrix or a vector, and d is a correlation vector.

3. The method of claim 1, wherein the pulse position likelihood estimation vector is calculated using a pitch residue signal and correlation vector information.

4. The method of claim 1, wherein the pulse position likelihood estimation vector is calculated by the following Equation:
$$b ( n ) = \frac{{r}_{LTP} ( n )}{\sqrt{{\sum }_{i = 0}^{39} {r}_{LTP} ( i ) {r}_{LTP} ( i )}} + \frac{d ( n )}{\sqrt{{\sum }_{i = 0}^{39} d ( i ) d ( i )}} ,$$
wherein r_{LTP}(n) is a pitch remaining signal and d is a correlation vector.

5. A computer readable medium having embodied thereon a computer program for a fixed codebook search method comprising:
calculating absolute values of pulse position likelihood estimation vectors for respective pulse positions for each track in a plurality of tracks;
selecting a predetermined number of pulse positions for each track in a descending order of the absolute values of the pulse position likelihood estimation vectors;
selecting one pulse position among the selected pulse positions for each track, per each track, creating all possible pulse position combinations consisting of the selected pulse positions, and conducting complete search for the all possible pulse position combinations; and
selecting one pulse position combination among the all possible pulse position combinations subjected to the complete search.

6. An apparatus for fixed codebook search comprising:
a unit for calculating an absolute value of a pulse position likelihood estimation vector, which calculates absolute values of pulse position likelihood estimation vectors for respective pulse positions for each track;
a pulse position selector which selects a predetermined number of pulse positions for each track in a descending order of the absolute values of the pulse position likelihood estimation vectors, using the absolute value information of the pulse position likelihood estimation vectors;
a unit for conducting a complete search, which selects one pulse position among the selected pulse positions for each track, per each track, creating all possible pulse position combinations consisting of the selected pulse positions, and conducts complete search for the all possible pulse position combinations; and
an optimal pulse position selector which selects one pulse position combination among the all possible pulse position combinations subjected to the complete search.

7. The apparatus of claim 6, wherein the pulse position likelihood estimation vector is decided using a pitch remaining signal and correlation vector information.

8. The apparatus of claim 6, wherein the pulse position likelihood estimation vector is calculated by the following Equation:
$$b ( n ) = \frac{{r}_{LTP} ( n )}{\sqrt{{\sum }_{i = 0}^{39} {r}_{LTP} ( i ) {r}_{LTP} ( i )}} + \frac{d ( n )}{\sqrt{{\sum }_{i = 0}^{39} d ( i ) d ( i )}} ,$$
wherein r_{LTP}(n) is a pitch remaining signal and d is a correlation vector.
